(19) United States
(12) Patent Application Publication
(10) Pub. No.: US 2026/0225866 A1
(43) Pub. Date: Aug. 6, 2026

(54) CONSTRUCTION JACK

(71) Applicant: MILWAUKEE ELECTRIC TOOL CORPORATION, Brookfield, WI (US)

(72) Inventors: John J. Rymsza, Wauwatosa, WI (US); Aidan J. Hall, Glen Ellyn, IL (US); Adam M. Schroeder, Waterford, WI (US); Samuel A. Gould, Wauwatosa, WI (US)

(21) Appl. No.: 19/451,227

(22) Filed: Jan. 16, 2026

Related U.S. Application Data
(60) Provisional application No. 63/752,138, filed on Jan. 31, 2025.

(51) Int. Cl. B66F 3/44; B66F 1/04; B66F 3/22

(52) U.S. Cl. CPC B66F 3/44; B66F 1/04; B66F 3/22

(57) ABSTRACT

A construction jack includes a base and a lift assembly coupled to the base. The lift assembly includes a housing, a powertrain assembly supported by the housing, the powertrain assembly including a motor configured to provide a rotational output, a track coupled to the base, and a lift plate supported by the track and configured to engage the workpiece, the lift plate configured to translate between a bottom position and a top position in response to rotation of the motor. A user interface coupled to the housing is configured to activate the motor and control a direction of motor rotation.

### CROSS-REFERENCE TO RELATED APPLICATIONS

This application claims priority to U.S. Provisional Patent Application No. 63/752,138, filed on January 31, 2025, the entire content of which is incorporated herein by reference.

### FIELD

The present disclosure relates to a jack, and more particularly to a construction jack for lifting a workpiece.

### BACKGROUND

Installation of a large workpiece (e.g., a cabinet, a door, a pre-hung window, etc.), typically requires a user to lift, level, and steady an item while securing the item to a wall. Lift/jack assemblies typically rely on a hand-operated ratchet system to incrementally lift the workpiece which may require two users to perform the lifting operation (e.g., one to steady the workpiece as it is lifted, one to operate the ratchet system). A lifting operation may be further complicated when more than one jack assembly is needed to support the workpiece as each jack assembly is separately operated.

### SUMMARY

The present disclosure provides, in one aspect, a construction jack configured to move a workpiece, the construction jack including: a base; a lift assembly coupled to the base, the lift assembly including a housing, a powertrain assembly supported by the housing, the powertrain assembly including a motor configured to provide a rotational output, a track coupled to the base, a user interface coupled to the housing and configured to activate the motor and control a direction of motor rotation, a lift plate supported by the track and configured to engage the workpiece, the lift plate configured to translate between a bottom position and a top position in response to rotation of the motor.

The present disclosure provides, in another aspect, a construction jack configured to move a workpiece, the construction jack including: a base; a track coupled to the base; and a lift assembly through which the track extends and along which the lift assembly is translatable, the lift assembly including a housing, a powertrain assembly supported in the housing, the powertrain assembly including a motor and transmission driven by the motor, the transmission engaging the track to translate the lift assembly along the track, a lift plate coupled to the housing and configured to engage the workpiece, a support assembly engaged with the track and configured to limit movement of the lift assembly along the track to linear translation, and an electronic control unit supported in the housing, the electronic control unit including a transceiver configured to send and receive signals; and a remote control configured to send signals to the transceiver to control operation of the construction jack.

The present disclosure provides, in another aspect, a construction jack system configured to move a workpiece, the construction jack system including: one or more construction jacks, each construction jack including a base; and a lift assembly coupled to the base including a housing, a track coupled to the base and extending through the housing; a powertrain assembly supported in the housing, the powertrain assembly including a motor and transmission driven by the motor, the transmission engaging the track to translate the lift assembly along the track, a trigger coupled to the housing and configured to activate the motor, a lift plate coupled to the housing and configured to engage the workpiece, a support assembly engaged with the track and configured to limit movement of the lift assembly along the track to linear translation, and a direction switch configured to control a direction of motor operation; and a controller configured to control operation of the one or more construction jacks.

Other features and aspects of the subject matter will become apparent by consideration of the following detailed description and accompanying drawings.

### BRIEF DESCRIPTION OF THE DRAWINGS

FIG. 1 is a rear perspective view of a construction jack in accordance with an embodiment of the disclosure.

FIG. 2 is a front perspective view of the construction jack of FIG. 1.

FIG. 3 is a cross-sectional view of the construction jack of FIG. 1.

FIG. 4 is a cross-sectional view of a construction jack in accordance with an embodiment of the disclosure.

FIG. 5 is a cross-sectional view of a construction jack in accordance with an embodiment of the disclosure.

FIG. 6 is a cross-sectional view of the construction jack of FIG. 5.

FIG. 7 is a perspective view of a construction jack in accordance with an embodiment of the disclosure.

FIG. 8 is a schematic diagram of a construction jack in accordance with an embodiment of the disclosure.

FIG. 9 is a perspective view of a construction jack in accordance with an embodiment of the disclosure.

FIG. 10 is a front view of the construction jack of FIG. 9, in a lowered position.

FIG. 11 is a cross-sectional view of the construction jack of FIG. 9, in a raised position.

FIG. 12 is a cross-sectional view of a portion of a construction jack in accordance with an embodiment of the disclosure.

FIG. 13 is a perspective view of a construction jack system in accordance with an embodiment of the disclosure.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

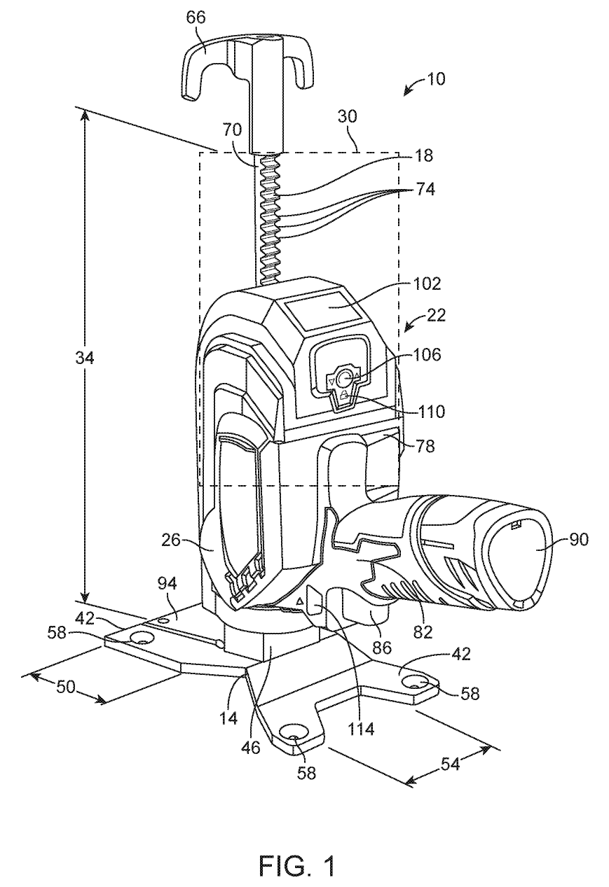

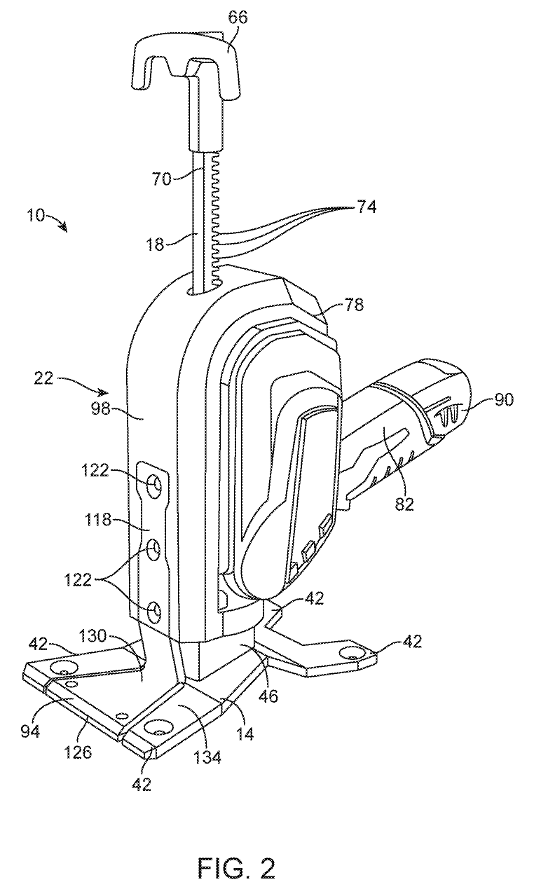

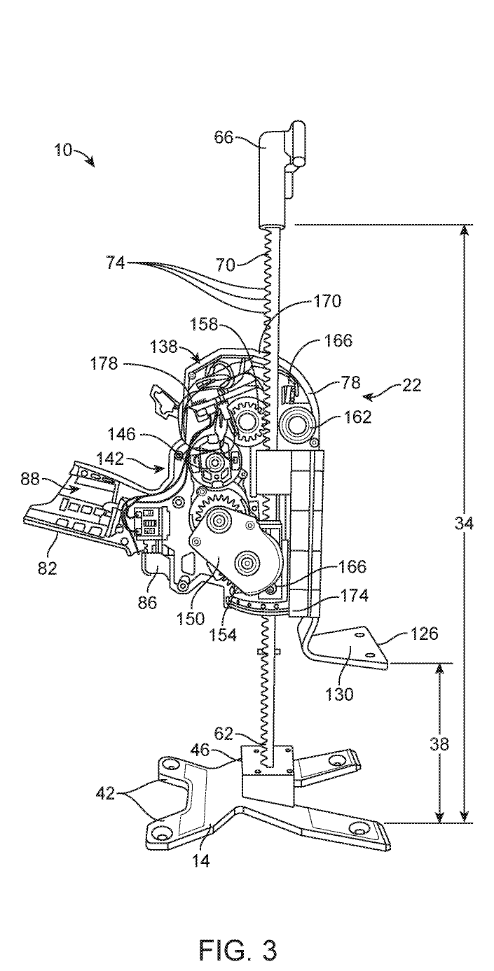

FIGS. 1-3 illustrate a construction jack 10 configured to lift a workpiece. The construction jack 10 includes a base 14, a track 18 coupled to the base 14, and a lift assembly 22 that is translatable along the track 18. The track 18 extends through the lift assembly 22 and defines a bottom position 26 (shown in FIG. 1), the lowest point from which a workpiece can be lifted, and a top position 30 (illustrated schematically), the highest point to which a workpiece can be lifted. A travel distance 34 is defined between the bottom position 26 and the top position 30. The travel distance 34 of the present embodiment is 9.5 inches, although a track 18 having a different length defining a different travel distance may be used. The lift assembly 22 selectively defines a lift height 38 (FIG. 3), a position between the bottom and top positions and corresponds to a point above the ground that the workpiece has been lifted to, or a starting point from which a workpiece is to be translated (e.g., raised or lowered).

The base 14 includes a plurality of legs 42 extending from a hub portion 46 to which the track 18 is coupled. The legs 42 have a length 50 and spread 54 (e.g., distance between the legs 42) to provide a stable support for the construction jack 10. Each leg 42 includes one or more holes 58 that may receive fasteners for securing the construction jack 10 to the floor for more stable lifting. The base 14 may be aluminum or other substantially strong and durable material for supporting the construction jack 10 and a workpiece having a weight up to 400 pounds.

The first end 62 of the track 18 is coupled to the hub portion 46 and track handle 66 is coupled to the opposite, second end 70 of the track 18 (FIG. 3). The track handle 66 prevents the lift assembly 22 from translating beyond the second end 70 of the track 18. The track handle 66 is also graspable to transport the construction jack 10 to a lifting location. The track 18 is configured as a rack (e.g., as part of a rack-and-pinion system). The track 18 has a plurality of teeth 74 that are positioned along the length of the track 18 between the first and second ends 62, 70.

The lift assembly 22 includes a housing 78 (e.g., a clamshell housing) having a handle 82 that supports a trigger 86 configured to control operation of the construction jack 10. A battery pack 90 (e.g., a 12 Volt battery pack, an 18 Volt battery pack, etc.) is removably couplable to the housing 78 (e.g., slidable into a receptacle 88 within the handle 82) to provide a power source for the construction jack 10. A lift plate 94 is coupled to the housing 78 on an opposite side 98 of the housing from the handle 82. The housing 78 also supports a display 102 (e.g., an LCD screen) that indicates the lift height 38 of the workpiece. In other embodiments, the display 102 may be omitted. Other controls may be supported by the housing 78, including a direction switch 106 (e.g., a manually pivotable switch, a push-button switch, or other switch type), a position lock 110, or other controls. The trigger 86, direction switch 106, and position lock 110 together form a user interface. In some embodiments, the display 102 may be coupled with one or more of the trigger 86, direction switch 106, and position lock 110. The housing 78 may also support a quick-adjust control 114 that allows the lift height 38 to be pre-set to align with a workpiece that has a lifting point that is offset from the ground.

The trigger 86 is a variable speed trigger that operates the construction jack 10 at different speeds to adjust the height of a workpiece. For instance, a first speed may operate the lift assembly 22 at a slower speed than a second speed. In the first speed operation, the lift height 38 of the construction jack is changed at a low rate of change to more accurately position the workpiece, while at the second operation speed, the lift height 38 of the construction jack 10 is changed at a higher rate of change in order to more quickly position the workpiece close to its mounting position, prior to operating at the first operating speed to precisely align the workpiece.

The lift plate 94 includes a mounting portion 118 that is coupled to the housing 78 with fasteners 122 and a support portion 126 having a planar surface 130. The support portion 126 extends perpendicularly from the mounting portion 118 away from the housing 78. In a lifting operation, a workpiece is supported on the planar surface 130 of the support portion 126. The support portion 126 is shaped to fit within the spread 54 between two of the legs 42, i.e., nested with the base 14, such that the planar surface 130 of the support portion 126 is substantially planar with or below a top surface 134 of the legs 42. The planar surface 130 defines the lift height 38 from the ground.

With reference to FIG. 3, the housing 78 defines a cavity 138 in which a powertrain assembly 142 is supported. The powertrain assembly 142 includes a motor 146 (e.g., a brushless DC motor) and a transmission 150 for converting the rotational output of the motor 146 to a translational output of the track 18. The powertrain assembly 142 may be substantially similar to the powertrain assembly disclosed in U.S. Patent No. 9,039,557, issued on May 26, 2015, filed as Application Serial No. 13/599,462 on August 30, 2012, the entire content of which is incorporated by reference herein. Engagement of the trigger 86, direction switch 106 and position lock 110 (i.e., the user interface) activate the motor 146, control the direction of motor rotation, and lock the motor 146. The transmission 150 includes an output gear 154 that is continuously engaged with the track 18. The transmission 150 receives a rotational output from the motor 146 and the meshed engagement of the output gear 154 of the transmission 150 with the plurality of teeth 74 of the track 18 translates the lift assembly 22 along the track 18. The transmission 150 may include one or more planetary stages to reduce the output speed of the motor 146.

An idle gear 158 and a bearing 162 (collectively, a “support assembly”) are positioned in the housing 78 on opposite sides of, and in engagement with, the track 18 to stabilize the construction jack 10 and to ensure that the lift assembly 22 translates linearly along the track 18. The lift assembly 22 is thereby limited to only linear translation along the track 18. The housing 78 also supports limit switches 166 at the top and bottom ends 170, 174 of the housing 78 to prevent the construction jack 10 from traveling beyond the limits of the track 18.

The housing 78 also supports an electronic controller 178 including a transceiver configured to receive signals from other components of the construction jack 10 (e.g., signals indicating motor direction, motor speed, output from the limit switches 166, etc.) and signal transmissions from external sources (e.g., a remote control), which the electronic controller 178 uses to control operation of the motor 146 (e.g., speed of operation, direction of operation) and output signals to the display 102 to indicate a condition of the construction jack 10 (e.g., lift height 38). In some embodiments of the jack 10, the transceiver may also wirelessly communicate with other power tools being used in tandem with the jack 10 to control operation of the jack 10.

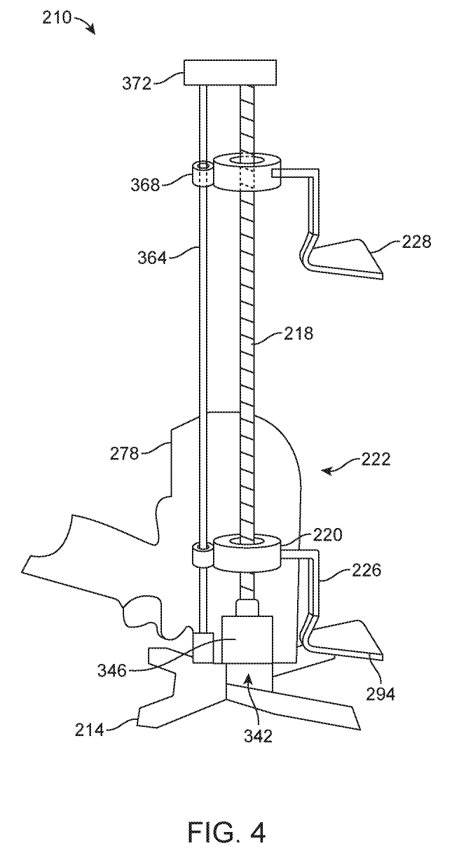

FIG. 4 illustrates another embodiment of a construction jack 210. Features and elements of the construction jack 210 corresponding to features and elements of the construction jack 10 described above are given identical reference numerals, plus 200. The construction jacks 10, 210 are similar, with only differences between the embodiments being described below.

The construction jack 210 includes a base 214 to which a lift assembly 222 is coupled. The lift assembly 222 includes a housing 278, a powertrain assembly 342 supported in the housing 278, and a track 218 that extends at least partially through the housing 278, and a lift plate 294 supported on the track 218. The housing 278 is coupled to the base 214 and is stationary relative to the base 214. The powertrain assembly 342 includes a motor 346 coupled to the housing 278 and the base 214. The track 218 is coupled to the motor 346 and is configured as a lead screw having threads extending along the length of the track 218. The motor 346 provides a rotational output that is transferred to the track 218 either directly, or through intervening components (e.g., a transmission assembly, a coupling, etc.).

A drive fastener 220 is threadedly coupled to the track 218 and is translatable along the track 218 between a bottom position 226 and a top position. Rotation of the motor 346 rotates the track 218 and threaded engagement between the track 218 and drive fastener 220 translates the drive fastener 220 along the track 218. The lift plate 294 is coupled to the drive fastener 220 and is translatable along the track 218 with the drive fastener 220 in response to rotation of the track 218 by the motor 346. The position of the drive fastener 220 and lift plate 294 are highly adjustable along the track 218, for instance, at any intermediate position 228. The drive fastener 220 may be configured in a “split nut” configuration in which the drive fastener 220 is openable (e.g., by a release mechanism) to allow the drive fastener 220 and the lift plate 294 to be moved relative to the track 218 allowing quick, manual adjustment of the position of the drive fastener 220 and the lift plate 294. It will also be appreciated that the construction jack 210 does not have “dead spots” or incremental indexing due to the continuous nature of the threading along the track 218. It will also be appreciated that the construction jack 210 is not “back drivable” in response to a heavy load, which improves safety and stability in heaving lifting situations.

The lift assembly 222 also includes a support assembly configured to limit movement of the lift plate 294 along the track 218 to linear translation. The support assembly includes a guide rail 364 that extends from the housing 278 and a guide bearing 368 that is slidable along the guide rail 364. The guide rail 364 and the track 218 are coupled to a support block 372. The track 218 is rotatably coupled to the support block 372 (e.g., by a bearing) to permit rotation of the track 218 relative to the support block 372. The guide bearing 368 is coupled to the drive fastener 220. The positioning of the guide bearing 368 on the track 218 prevents rotation of the drive fastener 220 relative to the track 218, thereby limiting the lift plate 294 to linear travel along the track 218.

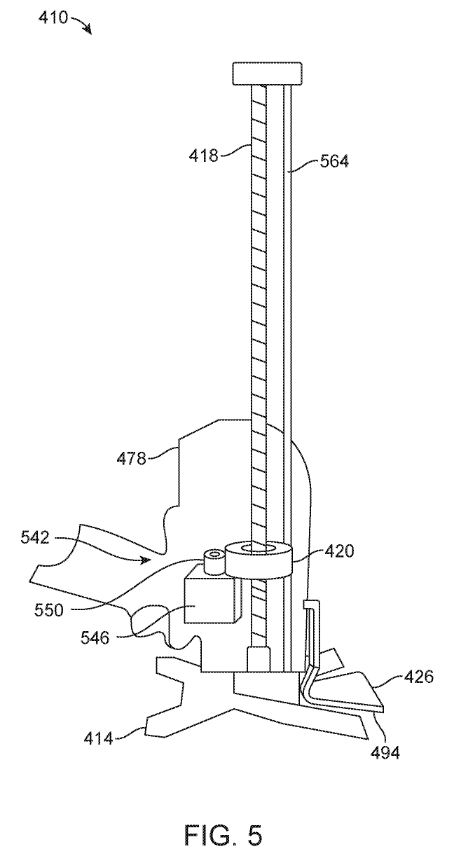

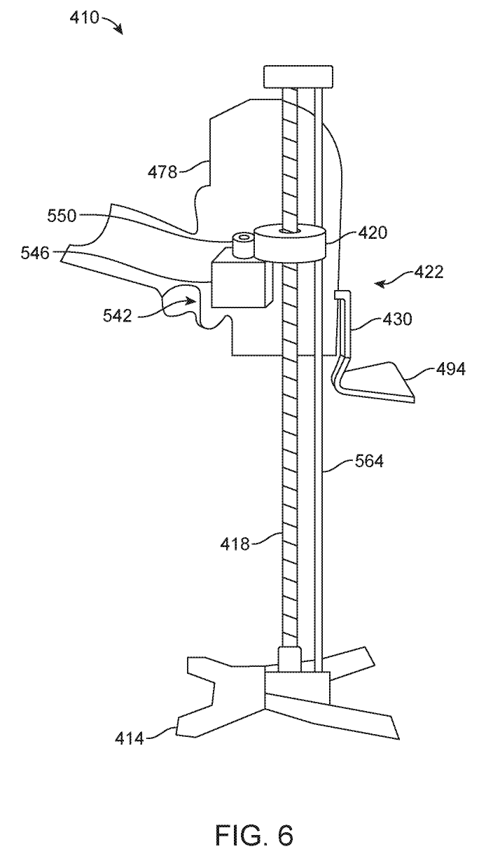

FIGS. 5-6 illustrate another embodiment of a construction jack 410. Features and elements of the construction jack 410 corresponding to features and elements of the construction jack 10 described above are given identical reference numerals, plus 400. The construction jacks 10, 410 are similar, with only differences between the embodiments being described below.

The construction jack 410 includes a base 414 to which a lift assembly 422 is coupled. The lift assembly 422 includes a housing 478, a powertrain assembly 542 supported in the housing 478, and a track 418 that extends at least partially through the housing 478, and a lift plate 494 coupled to the lift assembly 422 and supported on the track 418. The track 418 (configured as a lead screw similar to track 218) is fixedly coupled to the base 414. The housing 478 is coupled to the base 414 via the track 418 and is movable along the track 418 relative to the base 414. The powertrain assembly 542 includes a motor 546 coupled to the housing 478. The track 418 is configured as a lead screw having threads extending along the length of the track 418. The motor 546 provides a rotational output through a transmission 550 to a drive fastener 420 rotatably supported in the housing 478 and threadedly coupled to the track 418.

The housing 478, lift plate 494, and motor 546, transmission 550, and drive fastener 420 translate along the track 418 in response to rotation of the motor 546. Rotation of the motor 546 is transferred through the transmission 550 to the drive fastener drive fastener 420. Rotation of the drive fastener 420 translates the drive fastener along the track 418 between a bottom position 426 (FIG. 5) and a top position 430 (FIG. 6). The position of the drive fastener 420 and lift plate 494 with it are thereby highly adjustable along the track 418. The drive fastener 420 may be configured in a “split nut” configuration in which the drive fastener 420 is openable (e.g., by a release mechanism) to allow the drive fastener 420 and the lift plate 494 to be moved relative to the track 418 allowing quick, manual adjustment of the position of the drive fastener 420 and the lift plate 494. It will also be appreciated that the construction jack 410 does not have “dead spots” or incremental indexing due to the continuous nature of the threading along the track 418. It will also be appreciated that the construction jack 410 is not “back drivable” in response to a heavy load, which improves safety and stability in heaving lifting situations.

The lift assembly 422 also includes a support assembly configured to limit movement of the lift plate 494 along the track 418 to linear translation. The support assembly includes a guide rail 564 that extends through the housing 478. The housing 478 engages the guide rail 564 (e.g., with a guide bearing) to prevent rotation of the housing 478 and limit movement of the lift assembly 422 to linear translation.

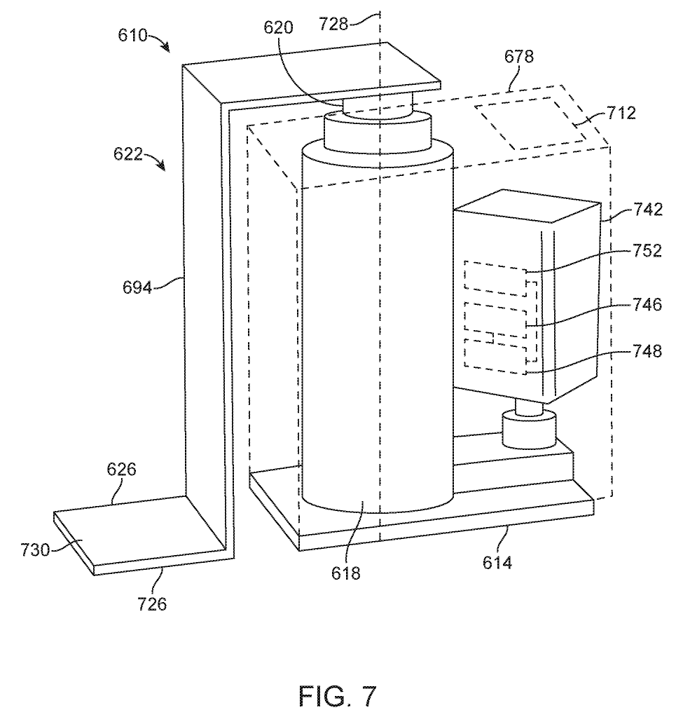

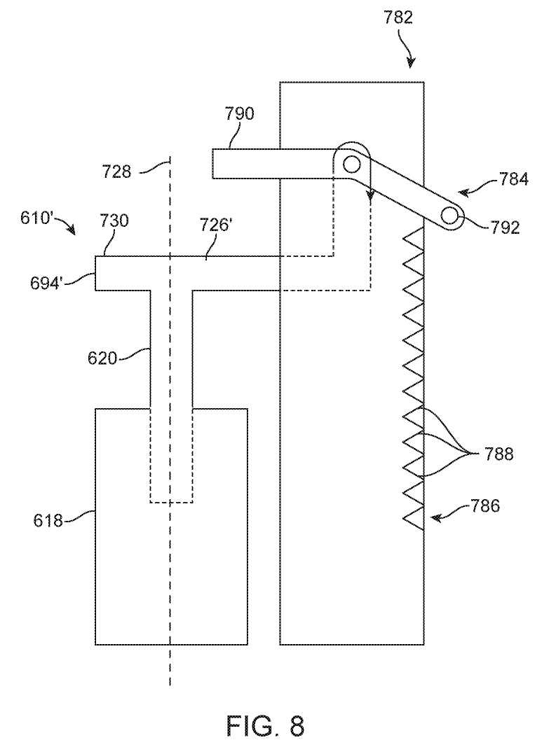

FIGS. 7-8 illustrate additional embodiments of a construction jack 610. The construction jack 610 includes a base 614 that is coupled to and supports a lift assembly 622. The lift assembly 622 includes a housing 678 that supports a powertrain assembly 742. The powertrain assembly 742 includes a motor 746 that provides a rotational output to a pump assembly 748 which receives hydraulic fluid from a reservoir 752 that is fluidly coupled to the pump assembly 748. In some embodiments, the pump assembly 748 may be configured to also return fluid to the reservoir 752 to store hydraulic fluid between successive lifting operations. In other embodiments, the fluid return may be accomplished in another manner. In some embodiments, a transmission may be coupled between the motor 746 and the pump assembly 748. The housing 678 supports a user interface 712 that is configured to activate the motor 746 and control a direction of motor rotation.

The lift assembly 622 includes a track 618 and a piston 620. The track 618 is coupled to the base 614 and is configured as a hydraulic cylinder that receives a flow of hydraulic fluid generated by the pump assembly 748. The track 618 slidably supports the piston 620. A lift plate 694 is coupled to the piston 620 and is thereby supported by the track 618. The piston 620 and lift plate 694 are translatable between a bottom position 626 (shown in FIG. 7) and a top position in response to rotation of the motor 746 and resulting operation of the pump assembly 748 to convey hydraulic fluid from the reservoir 752 to the track 618. The lift plate 694 is engageable with a workpiece to raise or lower the workpiece. The embodiment of FIG. 7 is configured as a side-lift construction jack 610 in which the lift plate 694 is an L-shaped lift plate that includes a support portion 726 with a planar surface 730 that is substantially planar with the base 614 and is offset from a line of translation 728 of the piston 620.

FIG. 8 illustrates another embodiment of a construction jack 610', which is substantially the same as construction jack 610, except for differences that will be described, with reference numerals appended with a prime symbol (‘).

The construction jack 610' of FIG. 8 is configured as an inline lift construction jack in which the lift plate 694’ is formed as a planar lift plate coupled to the top of the piston 620 with the planar support portion 726’ positioned above an inline with a line of translation 728 of the piston 620. In some embodiments, the lift plates 694, 694’ may be interchangeable so that the lift plates 694, 694’ can be changed depending on the nature of the object to be lifted.

The construction jack 610' in FIG. 8 also includes a support assembly 782 configured to limit movement of the piston 620 along the track 618 to linear translation. The support assembly 782 includes a ratcheting assembly 784 including a rack 786 positioned alongside and parallel to the track 618. The rack 786 defines a plurality of recesses 788 positioned along the rack 786 in a vertical direction. A locking arm 790 is pivotally coupled to the lift plate 694’ and translates with the lift plate 694’. The locking arm 790 includes a bar portion 792 that is disposable in the recesses 788 as the locking arm 790 and lift plate 694’ translate relative to the rack 786 and the track 618, respectively. The recesses 788 are shaped to prevent the bar portion 792 from being removed from a recess 788 under the downward force of workpiece acting on the lift plate 694’, without acting on the locking arm 790 to pivot the locking arm 790 and the bar portion 792 out of a recess 788. In some embodiments, the locking arm 790 may be manually pivoted or mechanically pivoted (e.g., by a motor).

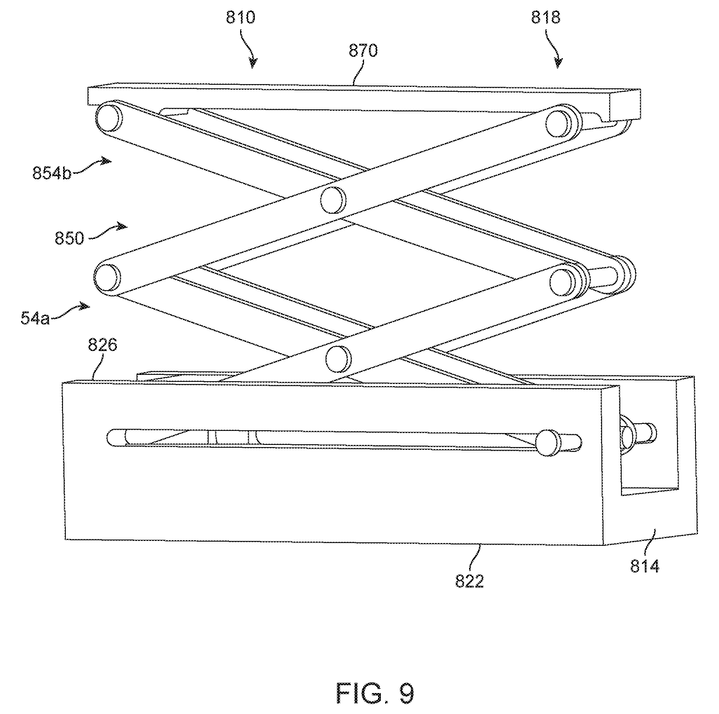

FIGS. 9-11 illustrate another embodiment of a construction jack 810. The construction jack 810 includes a base 814 and a lift assembly 818 coupled to the base 814. The base 814 includes a base portion 822 that is configured to be placed on a surface. The lift assembly 818 includes a housing portion 826 (or housing) that extends from the base 814 and a powertrain assembly 830 that is supported by the housing portion 826. The powertrain assembly 830 includes a motor 834 that provides a rotational output to a track 838. The track 838 is configured as a lead screw that is rotatably supported by the housing portion 826 and the base portion 822 via the motor 834. In some embodiments, a transmission assembly may be coupled between the motor 834 and the track 838. The track 838 extends through the housing portion 826 in an extension direction 842 that is perpendicular to the direction of translation 846 of the lift assembly 818.

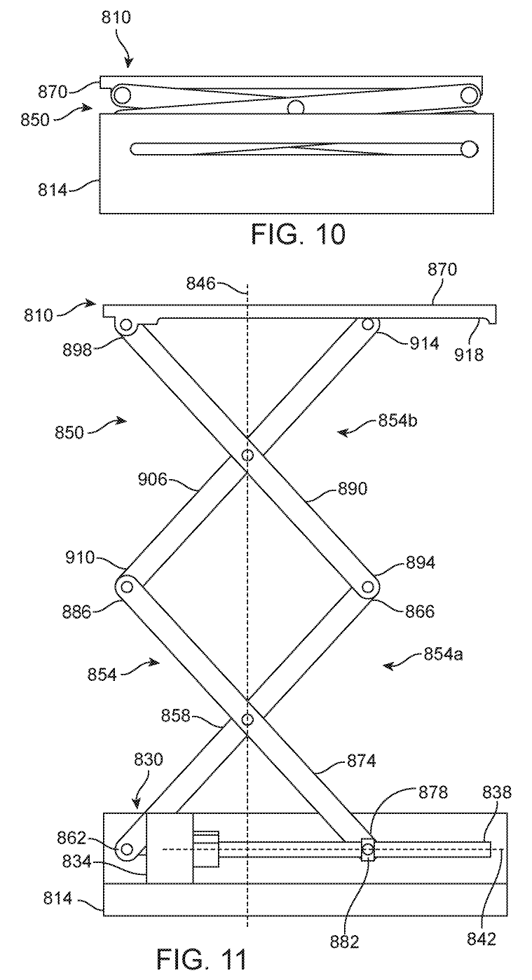

The lift assembly 818 further includes a scissor mechanism 850 that includes one or more linkage assemblies 854. The illustrated embodiment includes two linkage assemblies, lower linkage assembly 854a and upper linkage assembly 854b, although one linkage assembly or more than two linkage assemblies may be used instead, which may depend on desired lift height, size of the construction jack, etc. FIG. 10 illustrates the construction jack 810 in greater detail. For the first and second linkage assemblies 854a, 854b shown in FIG. 10, only the rearward portion of the linkage assemblies are shown and referenced, however, it should be understood that the description is applicable also to the forward portions of the linkage assemblies. In the first linkage assembly 854a, a first link 858 is pivotally coupled at a first end 862 to the housing portion 826. The second end 866 is coupled to the lift plate 870 via the second linkage assembly 854b. A second link 874 of the first linkage assembly 854a is pivotally coupled at its first end 878 to a threaded nut 882 that is threadedly supported on the track 838. The second end 886 of the second link 874 is pivotally coupled to the second linkage assembly 854b. The first link 858 and the second link 874 are pivotally coupled between the respective first and second ends of each link at the midpoint of each of the first and second links 858, 874.

In the illustrated embodiment, the second linkage assembly 854b includes a first link 890 that is pivotally coupled at its first end 894 to the second end 866 of the first link 858 of the first linkage assembly 854a and at its second end 898 to the lift plate 870. The second link 906 of the second linkage assembly 854b is pivotally coupled at its first end 910 to the second link 874 of the first linkage assembly 854a. The second end 914 of the second link 906 is positioned in a groove 918 of the lift plate 870 and translates along the groove 918. The first link 890 and second link 906 are pivotally coupled between their respective first and second ends.

Rotation of the motor 834 and the track 838 translates the threaded nut 882 along the track 838. As the threaded nut 882 translates, the first end 878 of the second link 874 travels with the threaded nut 882. The pivotal coupling of the first and second links 858, 874 results in raising or lowering the lift plate 870 between the bottom position (FIG. 10) and the top position (FIG. 11).

In some embodiments, a covering (e.g., a collapsible accordion-style covering) at least partially surrounds the linkage pairs 854. A user interface may be coupled to the housing and configured to activate the motor 834 and control a direction of motor rotation.

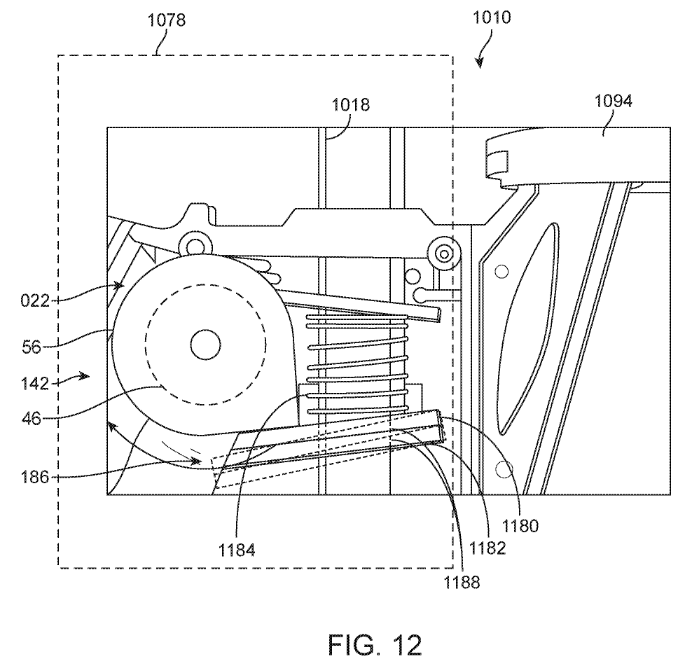

FIG. 12 illustrates a portion of another embodiment of a construction jack 1010. Features and elements of the construction jack 1010 corresponding to features and elements of the construction jack 10 described above are given identical reference numerals, plus 1000. The construction jacks 10, 1010 are substantially similar, with only differences between the embodiments being described below.

The construction jack 1010 includes a lift assembly 1022. The lift assembly 1022 includes a powertrain assembly 1142 including a motor 1146 supported in a housing 1078. The motor 1146 is coupled to a cam 1156 to rotate the cam 1156. In some embodiments, a transmission may be coupled between the motor 1146 and the cam 1156. A track 1018 is coupled to the base in a similar manner as the track 18 of the construction jack 10. The lift assembly 1022 also includes a lift plate 1094 coupled to the housing 1078 and supported on the track 1018 to translate between bottom and top positions in response to rotation of the motor 1146.

The lift assembly 1022 further includes a first plate 1180 and a second plate 1182 that are supported on the track 1018. A biasing member (e.g., a spring 1184, such as a compression spring) is sleeved on the track 1018 and engages the second plate 1182 to bias the first plate 1180 and second plate 1182 to a first position (shown). The cam 1156 engages the first plate 1180 to pivot the first plate 1180 and the second plate 1182 to a second position 1186. In the second position 1186, the second plate 1182 binds with the track 1018 and translates the track 1018 relative to the housing 1078.

The track 1018 passes through holes 1188 in the first and second plates 1180, 1182, with the holes 1188 having a non-circular cross-section corresponding to the non-circular cross-section of the track 1018, which prevents rotation of the first and second plates 1180, 1182 about the track 1018 and limiting movement to translation along the track.

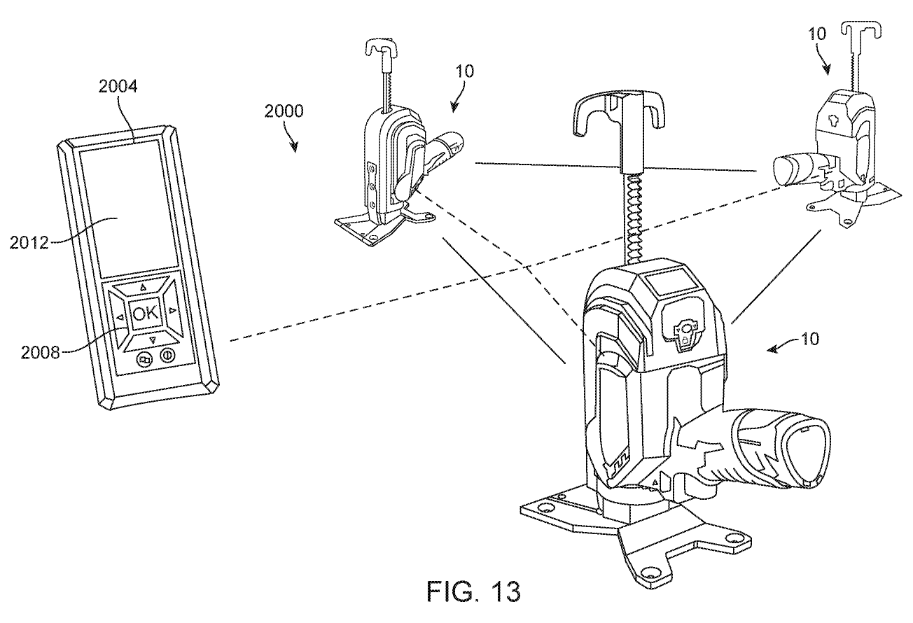

FIG. 13 discloses a construction jack system 2000. While the construction jack system 2000 is illustrated as including a first embodiment of a construction jack 10, it should be understood that any of the other previously described embodiments of construction jacks 210, 410, 610, 610’, 810, 1010 may be used in the construction jack system 2000 as discussed in the following description.

With reference to FIG. 13, a plurality of construction jacks 10 (e.g., between two and four construction jacks) are incorporated into a construction jack system 2000 in which the construction jacks 10 are operated by a remote control 2004, or external controller. The remote control 2004 (e.g., a wireless push-button remote control) transmits wireless signals (illustrated in dashed lines) to the individual transceivers in the construction jacks 10 for synchronized and/or asynchronized lifting. In a synchronized lifting operation, all the construction jacks 10 in the construction jack system 2000 simultaneously lift a workpiece at the same rate as described above in response to signals received from the remote control 2004. The individual jacks 10 may also wirelessly communicate with each other using signals (illustrated in solid lines) transmitted from and received by the transceivers onboard each of the construction jacks 10 to perform a synchronized lifting operation. The simultaneous lifting is completed at the same speed for each of the construction jacks 10. In an asynchronized lifting operation, one of the construction jacks 10 in the construction jack system 2000 is individually operated (following user selection via the remote control 2004) while the remaining construction jacks 10 are stationary. It will be appreciated that in an example of an asynchronized lifting operation is a leveling operation in which only one side or portion of a workpiece is lifted while the others remain stationary.

The remote control 2004 includes a plurality of buttons 2008 with which a user controls operation of the construction jack system 2000 and a display 2012 for indicating, for instance, the mode of operation, the speed, the lift height, etc. Using the plurality of buttons 2008, the user may select, for instance, a synchronized/asynchronized lifting operation, an individual construction jack to operate, input a target lift height, change direction of operation, etc.

The construction jack system 2000 may also include other external devices. In one embodiment, the external device may include one or more leveling devices. The leveling device is configured to sense the levelness of a workpiece and to communicate with each construction jack 10 of the construction jack system 2000 to automatically lift the workpiece so that it is level in all directions. The leveling device may be a device coupled, for instance, to a workpiece, or instead may be integrated in the remote control 2004. The leveling device senses the level of the workpiece in multiple directions (for instance, with an inertial measurement unit) at a standstill. The level measurements are communicated to a controller in the remote control 2004 and/or electronic controller 178 of each construction jack 10. The construction jack system 2000 would then perform a calibration routine to determine how movement of each construction jack 10 affects the orientation of the workpiece. In the calibration routine, each construction jack 10 is adjusted a predetermined amount while the others are stationary, and the rate of change of the level is determined, for instance, by the electronic controller 178. Once the rate of change for each construction jack 10 is determined, the controller determines the change for each construction jack 10 that would be necessary to level the workpiece. The construction jack 10 would then adjust the position of the workpiece accordingly.

Another example of an external device may be a laser detector that detects a laser indicator (e.g., from a laser level) and communicates with the controller in the remote control 2004 and/or electronic controller 178 of each construction jack 10 to automatically position the workpiece. In other embodiments, the laser detector may be integrated with a construction jack. In still other embodiments, each construction jack may generate a laser indicator that is detected by a laser detector, which communicates with the controller in the remote control 2004 and/or electronic controller 178 of each construction jack 10 to automatically position the workpiece.

While the above description of a leveling device describes sensing and automatically positioning a workpiece so that it is level, it should be understood that the leveling device may also be used to sense whether a workpiece is plumb and position the workpiece so that it is plumb.

While only lifting operations are described in detail above, it should be understood that the construction jacks 10, 210, 410, 610, 610’, 810, 1010 and construction jack system 2000 described above may be used for other operations, for instance, installing large equipment, horizontal and/or vertical leveling (e.g., vertically leveling concrete forms, horizontally leveling AC units, etc.).

Although the subject matter has been described in detail with reference to certain preferred embodiments, variations and modifications exist within the scope and spirit of one or more independent aspects of the subject matter as described.

Various features of the subject matter are set forth in the following claims.

What is claimed is:

1. A construction jack configured to move a workpiece, the construction jack comprising:
a base; and
a lift assembly coupled to the base, the lift assembly including
a housing,
a powertrain assembly supported by the housing, the powertrain assembly including a motor configured to provide a rotational output,
a track coupled to the base,
a lift plate supported by the track and configured to engage the workpiece, the lift plate configured to translate between a bottom position and a top position in response to rotation of the motor, and
a user interface coupled to the housing and configured to activate the motor and control a direction of motor rotation.

2. The construction jack of claim 1, wherein the powertrain assembly further includes a transmission driven by the motor, and wherein the transmission provides a rotational output to translate the lift plate.

3. The construction jack of claim 2, wherein the track is configured as a rack having a plurality of teeth positioned along a length of the rack, and wherein the transmission engages the rack to translate the lift assembly along the rack.

4. The construction jack of claim 1, wherein the lift assembly further includes a support assembly configured to limit movement of the lift assembly along the track to linear translation.

5. The construction jack of claim 2, wherein the track is configured as a lead screw.

6. The construction jack of claim 5, wherein the lead screw is fixedly coupled to the base.

7. The construction jack of claim 6, wherein the motor rotates a drive nut threadedly coupled to the lead screw and rotatably supported in the housing to translate the lift assembly along the lead screw.

8. The construction jack of claim 5, wherein the motor is coupled to the base, and wherein the lead screw is coupled to the motor and is rotated by the motor.

9. The construction jack of claim 8, wherein the lift assembly further comprises a drive fastener threadedly coupled to the lead screw, and wherein rotation of the lead screw translates the drive fastener along the lead screw.

10. The construction jack of claim 9, wherein the lift plate is coupled to the drive fastener.

11. The construction jack of claim 9, wherein the lead screw extends in a first direction that is perpendicular to a direction of translation of the lift plate.

12. The construction jack of claim 11, wherein the lift assembly further comprises a scissor mechanism including a first link pivotally coupled at a first end to the housing and at second end to the lift plate, and a second link pivotally coupled at a first end to the lead screw and at a second end to the lift plate, and wherein the first link and the second link are pivotally coupled between their respective first and second ends.

13. The construction jack of claim 1, wherein the track is configured as a hydraulic cylinder, wherein the powertrain assembly includes a pump that receives the rotational output from the motor and a hydraulic reservoir configured to store a quantity of hydraulic fluid, wherein the pump generates a flow of the hydraulic fluid to the hydraulic cylinder to translate a piston supported in the hydraulic cylinder, and wherein the lift plate is coupled to the hydraulic cylinder.

14. The construction jack of claim 11, further comprising a ratcheting assembly including a rack having a plurality of recesses and a locking arm pivotally coupled to the lift plate and translatable with the lift plate, wherein the locking arm includes a bar portion that is disposable in the recesses.

15. The construction jack of claim 1, wherein the lift plate has a mounting portion coupled to the housing and a support portion that extends perpendicularly from a mounting portion, and wherein the support portion engages the workpiece.

16. The construction jack of claim 15, wherein the support portion is nested in the base when the lift plate is in the bottom position.

17. The construction jack of claim 1, wherein the lift plate has a planar shape.

18. The construction jack of claim 1, wherein the lift assembly further comprises a cam coupled to the motor, a first plate and a second plate supported on the track, and a spring engaging the second plate to bias the first plate and the second plate to a first position, and wherein the cam engages the first plate to pivot the first plate and the second plate to a second position in which the second plate binds with the track to translate the track.

19. A construction jack configured to move a workpiece, the construction jack comprising:
a base;
a track coupled to the base;
a lift assembly through which the track extends and along which the lift assembly is translatable, the lift assembly including
a housing,
a powertrain assembly supported in the housing, the powertrain assembly including a motor and transmission driven by the motor, the transmission engaging the track to translate the lift assembly along the track,
a lift plate coupled to the housing and configured to engage the workpiece, and
a support assembly engaged with the track and configured to limit movement of the lift assembly along the track to linear translations, and
an electronic control unit supported in the housing, the electronic control unit including a transceiver configured to send and receive signals; and
a remote control configured to send signals to the transceiver to control operation of the construction jack.

20. A construction jack system configured to move a workpiece, the construction jack system comprising:
one or more construction jacks, each construction jack including
a base,
a lift assembly coupled to the base including
a housing,
a track coupled to the base and extending through the housing,
a powertrain assembly supported in the housing, the powertrain assembly including a motor and transmission driven by the motor, the transmission engaging the track to translate the lift assembly along the track,
a trigger coupled to the housing and configured to activate the motor,
a lift plate coupled to the housing and configured to engage the workpiece,
a support assembly engaged with the track and configured to limit movement of the lift assembly along the track to linear translation, and
a direction switch configured to control a direction of motor operation; and
a controller configured to control operation of the one or more construction jacks.
